(19) United States
(12) Patent Application Publication
(10) Pub. No.: US 2009/0075644 A1
(43) Pub. Date: Mar. 19, 2009

(54) SYSTEM AND METHOD FOR SELECTIVELY REJECTING FREQUENCY BANDS IN WIRELESS COMMUNICATION SYSTEMS

(75) Inventor: Michael J. Hermel, Waseca, MN (US)

Correspondence Address: FOGG & POWERS LLC, 5810 W 78TH STREET, SUITE 100, MINNEAPOLIS, MN, 55439, US

(73) Assignee: ADC TELECOMMUNICATIONS, INC., Eden Prairie, MN (US)

(21) Appl. No.: 11/857,537

(22) Filed: Sep. 19, 2007

(51) Int. Cl. H04Q 7/20

(52) U.S. Cl. 455/422.1

(57) ABSTRACT

A system and method for selectively rejecting frequency bands in wireless communication systems are disclosed. For example, the system provides a software-selective band rejection technique using multiple cascaded band rejection filters that can remove undesired sub-bands within the RF pass band of the wireless communication system, subsystem or network involved. Thus, the system enables the remaining or desired sub-bands in that RF pass band to be passed. Consequently, the software-oriented band rejection approach enables a designer, operator or user to rapidly configure or reconfigure its designated bands or sub-bands (e.g., on an application-by-application basis) without having to procure and install new bandpass filter hardware or other filter hardware.

### FIELD OF THE INVENTION

The present invention relates generally to the wireless communications field, and more specifically, but not exclusively, to a system and method for selectively rejecting frequency bands in wireless communication systems.

### BACKGROUND OF THE INVENTION

In certain wireless communication systems, such as for example, mobile radiotelephone or cellular communication systems, the available radio spectrum is designated for use by network operators in specific frequency bands. For example, there are eight frequency bands allocated for use by network operators in the Global System for Mobile Communications (GSM). Specifically, the GSM-850 and GSM-1900 bands are the primary bands designated for use by GSM network operators in the United States, Canada and parts of South and Central America, and the GSM-900 and GSM-1800 bands are the primary bands designated for use by GSM network operators in other parts of the world. As other examples, there are ten frequency bands designated for use by operators of Universal Mobile Telecommunications System (UMTS) Wideband-Code Division Multiple Access (W-CDMA) Frequency Division Duplex (FDD) networks, and six frequency bands designated for use by operators of UMTS-Time Division Duplex (TDD) networks.

In these and similar other mobile radiotelephone or cellular communication systems, the designated frequency bands are typically divided into sub-bands, and multiple sub-bands are assigned to different network operators. For example, the GSM-850 band is divided into four sub-bands, and the GSM-1900 band is divided into six sub-bands. Thus, for this example, a GSM network operator might be allocated the use of up to six sub-bands for uplink and downlink communications.

A significant problem with the allocation of frequency spectrum in existing mobile radiotelephone or cellular communication systems is that the sub-bands assigned to the network operators are typically not contiguous. Also, the same sub-bands are often not used for the same or similar applications in different regions across a country or across the world. Consequently, this lack of sub-band standardization causes the design and configuration of existing mobile radiotelephone or cellular communication networks to be inflexible, and also costly if one or more of a network operator's sub-band allocations are changed and the network has to be reconfigured to accommodate such a change.

For example, mobile radiotelephone or cellular communication network operators design their network circuitry to pass the frequencies of their assigned sub-bands, and reject all others. The operators traditionally use different hardware bandpass filters to pass their assigned sub-bands and reject the others. However, if an operator has to add or subtract one or more sub-bands to or from an existing network configuration, then the operator has to procure and install one or more new bandpass filters to accommodate such a change. This hardware-oriented bandpass filter approach is costly and also results in decreased operating time. Therefore, a pressing need exists for an approach that can be used to reject (and pass) frequency bands or sub-bands in wireless communication systems, which will increase the design and configuration flexibility of the networks involved, and minimize their hardware costs and configuration and reconfiguration times.

### SUMMARY OF THE INVENTION

The present invention provides a system and method for selectively rejecting frequency bands in wireless communication systems. For at least one example embodiment, the system and method provide a software-selective band rejection technique using multiple cascaded band rejection filters that can remove undesired sub-bands within the RF pass band of the wireless communication system, subsystem or network involved. Thus, the present invention enables the remaining or desired sub-bands in that RF pass band to be passed. Consequently, the software-oriented band rejection approach of the present invention enables an operator or user to rapidly configure or reconfigure its designated bands or sub-bands (e.g., on an application-by-application basis) without having to procure and install new bandpass filter hardware or other filter hardware.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a block diagram of an example wireless communication system, which can be used to implement one or more embodiments of the present invention;

FIG. 2 is a block diagram depicting an illustrative example of a programmable notch filter unit, which can be used to implement the first programmable notch filter unit or the second programmable notch filter unit in the one or more example embodiments depicted in FIG. 1; and

FIG. 3 is a pictorial representation depicting an illustrative example of frequency responses for the exemplary programmable notch filters depicted in FIG. 2.

### DETAILED DESCRIPTION OF PREFERRED EMBODIMENT

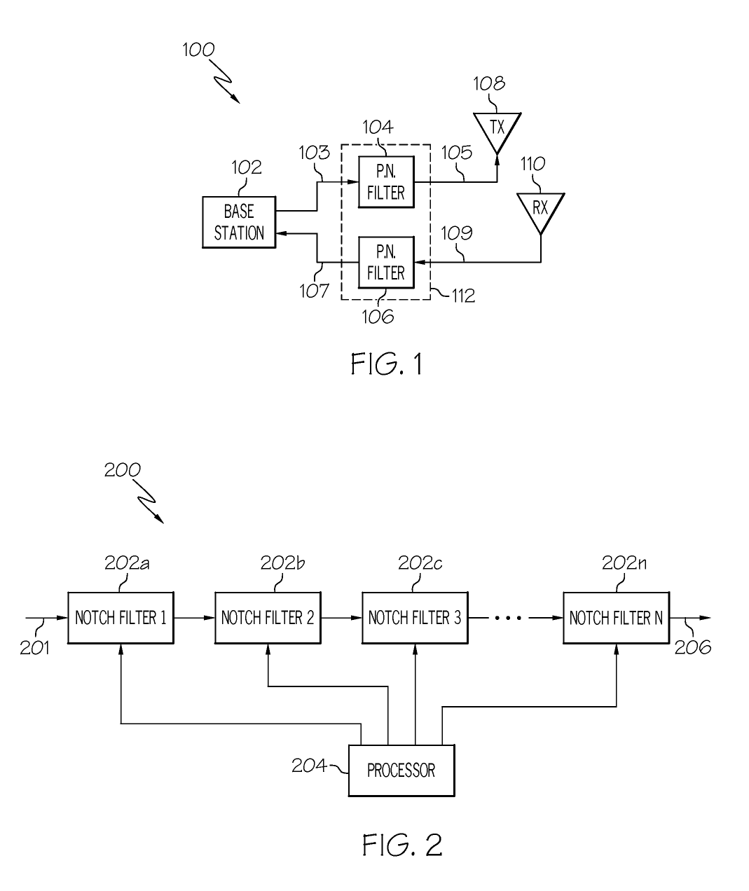

With reference now to the figures, FIG. 1 depicts a block diagram of an example wireless communication system 100, which can be used to implement one or more embodiments of the present invention. For at least one example embodiment, system 100 may be used to implement a mobile radiotelephone or cellular communication system including a network configured with a plurality of cells (e.g., macro-cells, micro-cells, pico-cells, or a combination thereof). For example, system 100 may be used to implement a wireless communication system including a network operated in accordance with one of the known telecommunications network protocols, such as the protocol for the Global system for Mobile Communications (GSM), Advanced Mobile Phone System (AMPS), Digital-AMPS (D-AMPS), Code Division Multiple Access (CDMA), Wideband CDMA (WCDMA), Time Division Multiple Access (TDMA), Cellular Digital Packet Data (CDPD), Enhanced Data rates for GSM Evolution (EDGE), General Packet Radio Service (GPRS), Integrated Enhanced Data Network (iDEN), Orthogonal Frequency Division Multiplexing (OFDM), Orthogonal Frequency Division Multiple Access (OFDMA), Universal Mobile Telecommunication System (UMTS), 3 Generation Partnership Project (3GPP), 3GPP2, Wireless Fidelity (WiFi), Worldwide Interoperability for Microwave Access (WiMAX), RF Identification (RFID), and similar other wireless (terrestrial or airborne) protocols. In any event, it should be understood that the type of wireless communications system, subsystem or network actually implemented is simply a design choice, and the present invention is not intended to be limited to the use of a specific type of wireless communication system, subsystem, network and/or protocol.

More generally, for example, system 100 may be used to implement part or all of any suitable wireless communication system, subsystem or network that can transport multiple bands or sub-bands of radio spectrum frequencies. System 100 may also be used to implement any suitable apparatus, product or method that can be used to transport Radio Frequency (RF) signals in pre-selected bands or sub-bands from one location to another location within the wireless communication system, subsystem or network involved.

Essentially, in accordance with the teachings of the present invention, system 100 provides a software-selective band rejection technique using, for at least one example embodiment, multiple cascaded band rejection filters that can remove undesired sub-bands within the RF pass band of the wireless communication system, subsystem or network involved. Thus, system 100 enables the remaining or desired sub-bands in that RF pass band to be passed. Consequently, the software-oriented band rejection approach of system 100 enables an operator, designer or other user to rapidly configure or reconfigure its allocated bands or sub-bands (e.g., on an application-by-application basis) without having to procure and install new bandpass filter hardware or other filter hardware.

Referring now to FIG. 1 for one or more example embodiments, system 100 includes a base station 102, which is communicatively coupled via a suitable wired or wireless link 103 to a first programmable notch filter unit 104. As described in more detail below, programmable notch filter unit 104 includes a plurality of software-controllable notch filters. A predetermined combination of some or all of these notch filters can be tuned to remove (reject) a predetermined portion (e.g., an entire sub-band, a plurality of sub-bands, etc.) of the frequency band involved. In other words, for example, the cascaded sum of the plurality of notch filters used can remove any undesired sub-band of frequencies of the band involved, and the remaining desired sub-band(s) can be passed.

The RF signals in the passed frequency sub-band(s) are transported from first programmable notch filter unit 104 via a suitable wired or wireless link 105 to a transmit antenna unit 108. For example, transmit antenna unit 108 can be used to provide RF signal coverage in remote locations (e.g., airports, buildings, urban areas, etc.). As another example, transmit antenna unit 108 can be a downlink transmitter section of a wireless signal repeater (or relay, for analog signals). As still example, transmit antenna unit 108 can be a downlink transmitter within a set of remotely located, distributed antennas. In any event, transmit antenna unit 108 can be operated in accordance with any suitable, known radio air interface protocol.

For one or more example embodiments, system 100 also includes a receive antenna unit 110. For example, receive antenna unit 110 can be a receive antenna (e.g., diversity receive antenna) used to provide suitable uplink RF signal coverage at or near the same location as transmit antenna unit 108. Receive antenna unit 110 is communicatively coupled via a suitable wired or wireless link 109 to a second programmable notch filter unit 106. Essentially, second programmable notch filter unit 106 functions similarly to that of first programmable notch filter unit 104, except second programmable notch filter unit 106 can be used to selectively reject uplink RF signals in the undesired (uplink) sub-bands or frequencies for the wireless communication system, subsystem or network involved. Notably, in some example embodiments, as indicated by the dashed rectangular block labeled 112, the programmable notch filter units 104 and 106 may be co-located. In other example embodiments, the programmable notch filter units 104 and 106 may be at different locations. Also, in some example embodiments, the programmable notch filter units 104 and 106 may be implemented as a single apparatus. In other example embodiments, the programmable notch filter units 104 and 106 may be implemented as separate devices. In any event, the RF signals in the passed frequency sub-bands (or bands) are transported from second programmable notch filter unit 106 via a suitable wired or wireless link 107 to base station 102.

FIG. 2 is a block diagram depicting an illustrative example of a programmable notch filter unit 200, which can be used to implement the first programmable notch filter unit 104 or the second programmable notch filter unit 106 in the one or more example embodiments depicted in FIG. 1. For one or more example embodiments, programmable notch filter unit 200 includes a plurality of programmable notch filters 202a through 202n, where “n” represents the value of “N” or the total number of notch filters involved. A digital processor unit 204 is connected and enabled to send suitable control signals to each programmable notch filter 202a-202n. One or more suitable notch filter algorithms can be executed as software instructions by digital processor unit 204, in order to control the band rejection functions of each programmable notch filter 202a-202n. Note that the digital processor unit 204 may be co-located with the programmable notch filters 202a-202n or located elsewhere (e.g., at the base station 102).

A notch filter is a type of band-stop or band rejection filter, which passes most frequencies unaltered, but severely attenuates those frequencies in a specific range or band. Thus, in accordance with the present invention, a network designer, operator or user can configure a network's sub-bands by entering suitable instructions to digital processor unit 204, which in turn, can tune predetermined ones of the programmable notch filters 202a-202n to remove a selected portion (e.g., an entire sub-band, multiple sub-bands, etc.) of the pass band involved. The remaining frequencies (e.g., one or more sub-bands) of the pass band can be passed. For example, a designer, operator or user of a GSM-850 network might instruct digital processor unit 204 to tune the programmable notch filters 202a-202n to remove or reject one of the four allocated GSM-850 sub-bands, and thus the other three sub-bands can be passed.

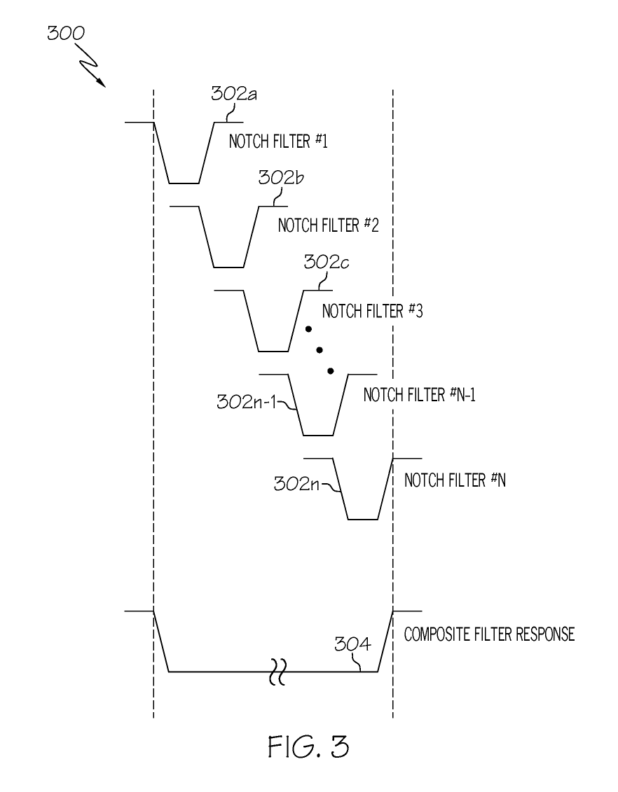

FIG. 3 is a pictorial representation depicting an illustrative example of frequency responses 300 for the exemplary programmable notch filters 202a-202n depicted in FIG. 2. In this illustrative example, a plurality of frequency responses 302a through 302n is shown, and the cascaded sum of the frequency responses 302a-302n is represented by the composite frequency response 304. For example, the composite frequency response 304 may represent a sub-band of an RF pass band that a user desires to remove or reject. As such, referring to FIG. 2, the input 201 might represent RF signals spanning the sub-bands of frequencies of an entire RF pass band for a wireless communication system, subsystem or network involved, and the output 206 would represent the RF signals present at the input 201 minus the sub-band(s) of frequencies rejected or removed in accordance with the composite frequency response 304.

At this point, it is important to note that although the illustrative example depicted in FIG. 3 shows a composite frequency response (304) for all of the programmable notch filters 202a-202n shown in FIG. 2, the present invention is not intended to be limited to just the notch filter configuration shown. For example, in a different embodiment, a user might instruct digital processor unit 204 to control selected ones of the programmable notch filters 202a-202n (e.g., 202a-d and 202h-k), in order to reject two or more different (e.g., non-contiguous) sub-bands. In other words, programmable notch filters 202a-202n may be controlled by digital processor unit 204 to reject one or more contiguous or non-contiguous sub-bands, or multiple sets of the programmable notch filters 202a-202n may be controlled by the digital processor to reject multiple contiguous or non-contiguous sub-bands.

It is important to note that while the present invention has been described in the context of a fully functioning software-selective band rejection system or method, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular software-selective band rejection system or method.

The description of the present invention has been presented for purposes of illustration and description, and is not intended to be exhaustive or limited to the invention in the form disclosed. Many modifications and variations will be apparent to those of ordinary skill in the art. These embodiments were chosen and described in order to best explain the principles of the invention, the practical application, and to enable others of ordinary skill in the art to understand the invention for various embodiments with various modifications as are suited to the particular use contemplated.

What is claimed is:

1. A system for selectively rejecting frequency bands in a wireless communication system, comprising:
a base unit;
a transmitter unit; and
a programmable band rejection unit coupled to the base unit and the transmitter unit, wherein the programmable band rejection unit is configured to:
selectively reject at least one predetermined band of frequencies from a plurality of bands of frequencies included in signals received from the base unit.

2. The system of claim 1, wherein the programmable band rejection unit is further configured to:
pass signals including a remainder of the plurality of bands of frequencies to the transmitter unit.

3. The system of claim 1, further comprising:
a receiver unit; and
a second programmable band rejection unit connected between the receiver unit and the base unit, wherein the second programmable band rejection unit is configured to:
selectively reject at least one predetermined band of frequencies from a second plurality of bands of frequencies included in signals received from the receiver unit.

4. The system of claim 3, wherein the second programmable band rejection unit is further configured to:
pass signals including a remainder of the second plurality of bands of frequencies to the receiver unit.

5. The system of claim 1, wherein the programmable band rejection unit comprises a plurality of programmable notch filters.

6. The system of claim 1, wherein the programmable band rejection unit comprises:
a plurality of programmable notch filters; and
a digital processor unit coupled to each programmable notch filter of the plurality of programmable notch filters.

7. The system of claim 1, further comprising:
a plurality of programmable notch filters; and
a digital processor unit co-located with and coupled to each programmable notch filter of the plurality of programmable notch filters, wherein the digital processor unit is configured to:
control a band rejection function of each programmable notch filter.

8. The system of claim 1, wherein the plurality of bands of frequencies comprises an RF pass band.

9. The system of claim 1, wherein the plurality of programmable notch filters comprises an RF transport device.

10. The system of claim 1, wherein the wireless communication system comprises a cellular communication system, the base unit comprises a base station, and the transmitter unit comprises an RF coverage transmit antenna.

11. A system for selectively rejecting sub-bands of frequencies in a wireless communication system, comprising:
a base station;
an RF coverage antenna subsystem; and
a plurality of programmable band rejection filters coupled to the base station and the RF coverage antenna subsystem, wherein the plurality of programmable band rejection filters is configured to:
select at least one sub-band of frequencies from a plurality of sub-bands of frequencies included in signals received from the base station; and
remove the at least one sub-band of frequencies from the plurality of sub-bands of frequencies.

12. The system of claim 11, wherein the plurality of programmable band rejection filters is further configured to:
pass a remainder of the plurality of sub-bands of frequencies to the RF coverage antenna subsystem.

13. The system of claim 11, wherein the plurality of programmable band rejection filters comprises a plurality of software-executable notch filters.

14. The system of claim 11, wherein the plurality of programmable band rejection filters is further configured to:
select at least one sub-band of frequencies from a second plurality of sub-bands of frequencies included in signals received from the RF coverage antenna subsystem; and
remove the at least one sub-band of frequencies from the second plurality of sub-bands of frequencies.

15. The system of claim 11, further comprising:
a digital processor coupled to the plurality of programmable band rejection filters and configured to:
control a filter function of each band rejection filter of the plurality of programmable band rejection filters.

16. A method for processing sub-bands of frequencies in a wireless communication system, comprising the steps of:
receiving signals including a plurality of sub-bands of frequencies;
selecting at least one sub-band of frequencies from the plurality of sub-bands of frequencies;
removing the at least one sub-band of frequencies from the plurality of sub-bands of frequencies; and
outputting signals including the plurality of sub-bands of frequencies minus the at least one sub-band of frequencies.

17. The method of claim 16, wherein the selecting step is performed by a digital processor.

18. The method of claim 16, wherein the removing step is performed by a plurality of programmable band rejection filters.

19. The method of claim 16, wherein the removing step is performed by a plurality of associated notch filters.

20. The method of claim 16, wherein the signals are uplink or downlink RF signals in a cellular communication system.
